(19) United States
(12) Patent Application Publication
(10) Pub. No.: US 2006/0197502 A1
(43) Pub. Date: Sep. 7, 2006

(54) METHOD AND SYSTEM FOR REJUVENATION OF AN ENERGY STORAGE UNIT

(75) Inventors: David L. Kaminsky, Chapel Hill, NC (US); David M. Ogle, Cary, NC (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/906,686

(22) Filed: Mar. 2, 2005

(51) Int. Cl. H02J 7/00

(52) U.S. Cl. 320/131

(57) ABSTRACT

A method for rejuvenation of an energy storage unit may include predicting at least one permissible time period to perform a rejuvenation process on the energy storage unit. The method may also include performing the rejuvenation process in response to one of detecting the at least one permissible time period, and both detecting the at least one permissible time period and the energy storage unit being in a predetermined state.

### BACKGROUND OF INVENTION

The present invention relates to mobile or portable electronic devices and more particularly to a method and system for rejuvenation or recharging of an energy storage unit, battery or the like for powering such electronic devices.

Virtually all mobile or portable electronic devices require a battery or some sort of energy storage unit (ESU) to provide power for the electronic device during mobile operation or when other external power sources may not be available. A new battery will have a maximum Watt-hour charge capacity. Over time and repeated charging and discharging cycles, the amount of charge capacity that the battery can hold will decrease. Some of the battery's original charge capacity may be recovered by a rejuvenation process. Battery rejuvenation is typically performed by fully draining or discharging and then fully recharging the battery. Depending upon a battery's capacity this can take several hours or longer. Low battery capacity or a battery nearing or within a rejuvenation process or recharging at a time when operation on battery power is necessary can be aggravating in the least and possibly result in adverse consequences under some situations. Accordingly, battery rejuvenation needs to be done when such an operation will be the least disruptive to the user.

### BRIEF SUMMARY OF INVENTION

In accordance with an embodiment of the present invention, a method for rejuvenation of an energy storage unit may include predicting at least one permissible time period to perform a rejuvenation process on the energy storage unit. The method may also include performing the rejuvenation process in response to one of detecting the at least one permissible time period, and both detecting the at least one permissible time period and the energy storage unit being in a predetermined state.

In accordance with another embodiment of the present invention, a system for rejuvenation of an energy storage unit may include a data structure operable on a processor to predict at least one permissible time period to perform a rejuvenation process on the energy storage unit. The system may also include a data structure operable on the processor to perform the rejuvenation process in response to one of detecting the at least one permissible time period, and both detecting the at least one permissible time period and the energy storage unit being in a predetermined state.

In accordance with another embodiment of the present invention, a computer program product for rejuvenation of an energy storage unit may include a computer readable medium having computer readable program code embodied therein. The computer readable medium may include computer readable program code configured to predict at least one permissible time period to perform a rejuvenation process on the energy storage unit. The computer readable medium may also include computer readable program code configured to perform the rejuvenation process in response to one of detecting the at least one permissible time period, and both detecting the at least one permissible time period and the energy storage unit being in a predetermined state.

### BRIEF DESCRIPTION OF THE SEVERAL VIEWS OF THE DRAWINGS

FIGS. 1A and 1B (collectively FIG. 1) are a flow chart of an example of a method for rejuvenation of an energy storage unit or the like in accordance with an embodiment of the present invention.

FIGS. 2A-2B (collectively FIG. 2) are a flow chart of an example of a method to predict or determine permissible time periods to perform a rejuvenation process in accordance with an embodiment of the present invention.

FIG. 3 is an example of an electronic device including an exemplary system for rejuvenation of an energy storage unit or the like in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

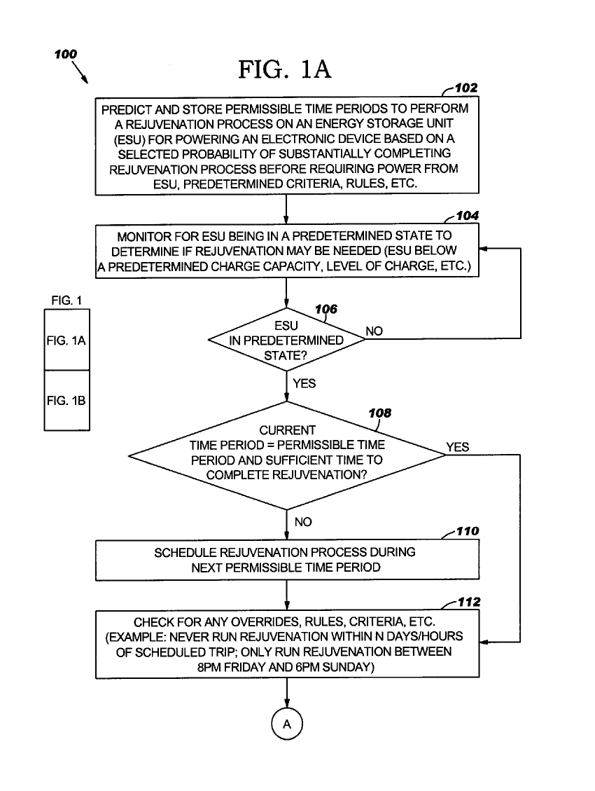

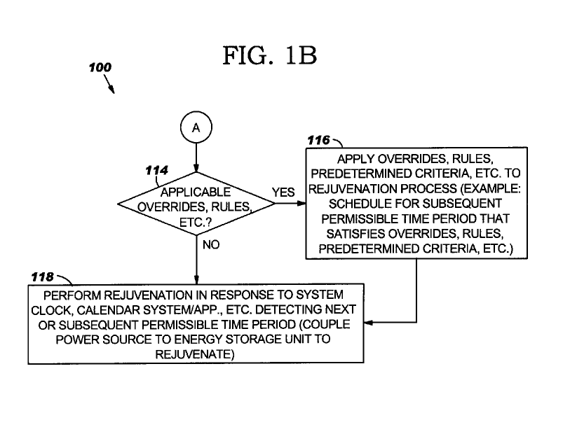

FIGS. 1A and 1B (collectively FIG. 1) are a flow chart of an example of a method 100 for rejuvenation of an energy storage unit or the like in accordance with an embodiment of the present invention. In block 102, permissible or optimum time periods to perform a rejuvenation process on an energy storage unit (ESU) may be predicted or determined. The rejuvenation process may involve fully discharging the ESU and then fully recharging the ESU. The present invention may also be applicable where an ESU is simply recharged from its current condition or state of charge without discharging. The ESU may be a battery, battery pack including multiple batteries, capacitor, capacitor bank, pulse generator or any type of device for storing energy that may require rejuvenation or recharging after powering an electronic device or the like. The rejuvenation process may be autonomic without any intervention by the user or requiring the user to initiate the rejuvenation process such as by operating a button or similar operation.

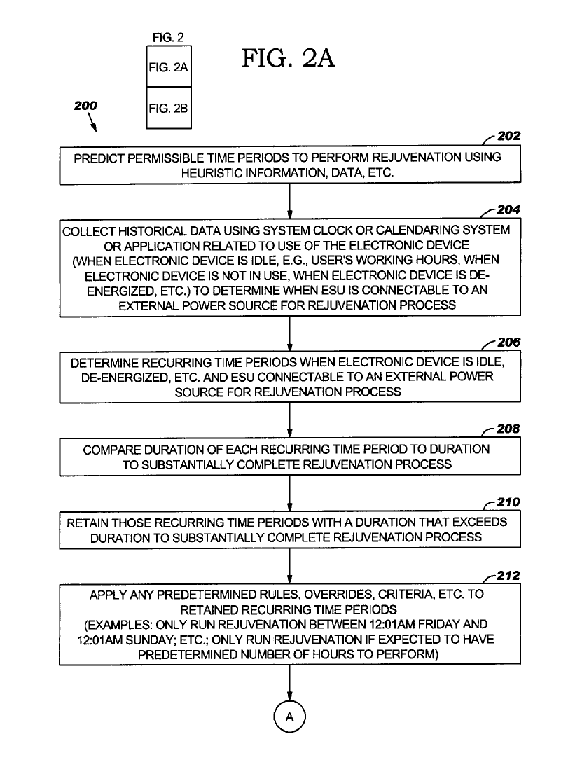

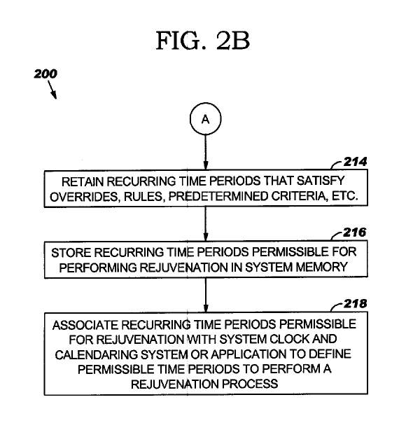

The permissible time periods to perform the rejuvenation process may be predicted in block 102 based a user selecting a probability of substantially completing the rejuvenation process before requiring power from the ESU. This may involve taking into account, characteristics of the ESU (size, type, capacity, and etcetera), characteristics of the charging equipment and algorithm (rapid charge, trickle charge and the like) and other possible charging parameters. In accordance with one embodiment of the present invention as will be described with reference to FIG. 2, the permissible time periods to perform rejuvenation may be predicted or determined from heuristic information, historical data or the like. From this information or data, determinations may be made which recurring time periods would most likely permit substantial completion of the rejuvenation process before requiring power from the ESU. Predicting or determining the permissible or optimum time periods may also involve consideration of predetermined criteria, rules or the like.

In block 104, the ESU may be monitored for being a in a predetermined state to determine when a rejuvenation may be needed. The predetermined state may be when the ESU is below a predetermined maximum charge capacity. The ESU may also be monitored to determine when the ESU is below a predetermined charge level and the present invention may be applicable to recharge the ESU in response to the ESU being below a predetermined charge level. In block 106, a determination may be made whether the ESU is in the predetermined state which may be below a predetermined level of charge or charge capacity. If the ESU is not in the predetermined state, the method 100 may continue to monitor the ESU in block 104. If the ESU is in the predetermined state in block 106, the method 100 may advance to decision block 108.

In block 108, a determination may be made if the current time period is a permissible time period and whether there may be sufficient time remaining in the current time period to substantially complete the rejuvenation process. If the current time period is a permissible time period and there is sufficient time remaining to substantially complete the rejuvenation process, the method 100 may advance to block 112. If the current time period is not a permissible time period or there is not sufficient time to substantially complete a rejuvenation in the current time period, the method 100 may advance to block 110. In block 110, a rejuvenation process may be scheduled for the next permissible time period.

In block 112, a check for any overrides, rules or other predetermined criteria or the like related to performing a rejuvenation process may be determined. For example, a rule or override may be stored in a memory of the electronic device or system and associated with the rejuvenation process to never run a rejuvenation process within a predetermined number of days or hours of a scheduled trip. The scheduled trip may be recorded in a calendar system or application on the electronic device or system which also may record the permissible rejuvenation time periods and detect conflicts therewith. Another example of a rule may be only to run a rejuvenation between 8 PM on a Friday and 6 PM on a Sunday. Thus possible disruption or inconvenience of the user may be minimized.

In block 114, a determination may be made whether there are applicable overrides, rules or other predetermined criteria from block 112 with regard to performing a rejuvenation process. If there are applicable rules, overrides or other predetermined criteria, the method 100 may advance to block 116. In block 116, the applicable rules, overrides or predetermined criteria may be applied to the rejuvenation process. For example, the method 100 or system may schedule the rejuvenation process for a subsequent time period that satisfies the overrides, rules or predetermined criteria. The method 100 may then advance to block 118 to perform the rejuvenation process.

If there are no applicable overrides, rules or other predetermined criteria in block 114, the method 100 may advance to block 118. In block 118, the rejuvenation process may be performed in response to a system clock, calendaring system or application detecting a next or subsequent permissible time period to perform the process. The energy storage unit may be coupled to an external power source, such as 110 volt alternating current (AC) or the like to perform the rejuvenation process.

In an alternate embodiment of the present invention, a rejuvenation process may be performed whenever there is a permissible time period that satisfies any overrides, rules or other predetermined criteria without monitoring the charge capacity of the energy storage unit. For example, the only permissible time period for performing a rejuvenation process may be over a weekend or other selected time period by the user.

FIGS. 2A-2B (collectively FIG. 2) are a flow chart of an example of a method 200 to predict or determine permissible time periods to perform a rejuvenation process in accordance with an embodiment of the present invention. In block 202, permissible time periods to perform rejuvenation processes on an energy storage unit for powering an electronic device may be predicted or determined. The permissible time periods may be determined heuristically using historical data or by other means. In block 204, historical data related use of the electronic device or when the electronic device is idle may be collected. Examples of the when the electronic device may be defined as idle may include (not an exclusive list): a) a user's normal working hours; b) when the electronic device is not being actively used; c) when the electronic device is de-energized or turned-off; d) or any time periods when the energy storage unit may be connectable to an external power source for a rejuvenation process with minimal inconvenience or disruption to the user. Such historical data or information may be determined using a system clock or calendaring system or application operable on the electronic device.

In block 206, recurring time periods when the electronic device is idle and the energy storage unit connectable to an external power source or the like for a rejuvenation process may be determined. In block 208, the duration of each recurring time period may be compared to a duration to substantially complete the rejuvenation process based on charging and discharging characteristics of the energy storage unit and characteristics or operating parameters of the rejuvenation equipment or components. In block 210, those recurring time periods with a duration that exceed the duration to substantially complete the rejuvenation process may be retained. In many cases, the rejuvenation process should be fully completed or the maximum benefit of recouping at least some lost charge storage capacity may not be entirely realized.

In block 212, any predetermined rules, overrides, criteria or the like may be applied to the retained recurring time periods from block 210. One example of an applicable rule or override may be to only run a rejuvenation process between 12:01 AM on Friday and 12:01 AM on Sunday. Another example of a rule or override may be to only run a rejuvenation if expected to have a predetermined number of hours to perform the rejuvenation before power from the energy storage unit may be needed.

In block 214, any recurring time periods that satisfy any predetermined overrides, rules, criteria or the like may be retained. In block 216, the recurring time periods permissive for performing rejuvenation may be stored in a system memory or the like. In block 218, the recurring permissive time periods for performing a rejuvenation process may be associated with the system clock and calendaring system or application to define permissible time periods to perform a rejuvenation process.

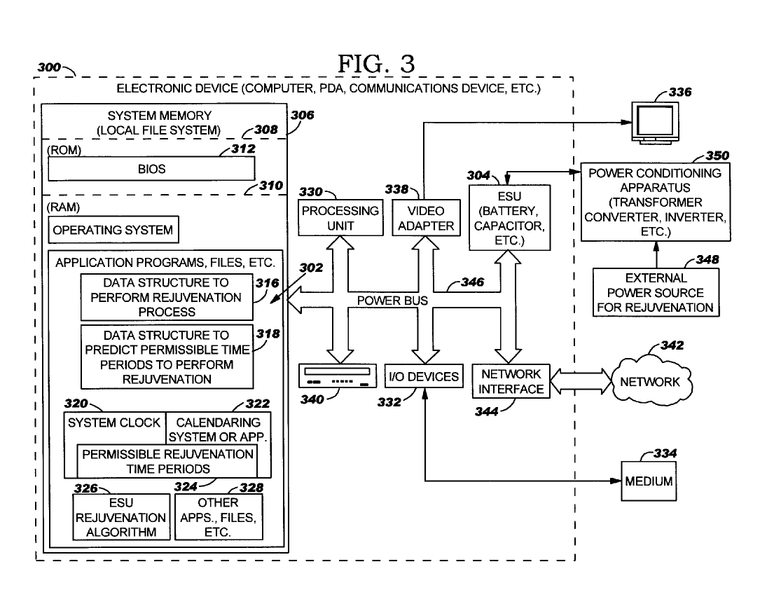

FIG. 3 is an example of an electronic device 300 including an exemplary system 302 for rejuvenation of an energy storage unit 304 or the like in accordance with an embodiment of the present invention. The method 100 of FIGS. 1A and 1B and method 200 of FIGS. 2A and 2B may be embodied in and performed by the system 302. The electronic device 300 may be a personal computer, personal data assistant (PDA), communications device, such as a cellular telephone, or any type electronic device that may be mobile and operable on power from the energy storage unit 304. The energy storage unit 304 may be a battery, battery pack containing multiple batteries, capacitor or capacitor bank, pulse power generator or any sort of device that may store energy and power the electronic device 300 when an external power source may not be available.

The electronic device 300 may include a system memory or local file system 306. The system memory 306 may include a read only memory (ROM) 308 and a random access memory (RAM) 310. The ROM 308 may include a basic input/output system (BIOS) 312. The BIOS 312 may contain basic routines that help to transfer information between elements or components of the electronic device 300. The RAM 310 may contain an operating system 314 to control overall operation of the electronic device 300. The RAM 310 may also include data structures 316 or computer-executable code to perform a rejuvenation process that may be similar to or include elements of the method 100 of FIGS. 1A and 1B. The RAM 310 may also include data structures 318 or computer-executable code to predict or determine permissible time periods to perform rejuvenations. The data structures 318 may be similar to or include elements of the method 200 of FIGS. 2A and 2B. The RAM 310 may further include a system a clock 320 and a calendaring system 322 or application. Permissible time periods 324 predicted or determined by data structure 318 may be superimposed on or associated with the system clock 320 or calendaring system 322.

The RAM 310 may also include a energy storage unit rejuvenation algorithm 326 that may control recharging or rejuvenation of the energy storage unit 304. The RAM 310 may further include other application programs 328, other program modules, data, files and the like for other purposes or functions.

The electronic device 300 may also include a processor or processing unit 330 to control operations of the other components of the electronic device 300. The operating system 314, data structures 316 and 318, system clock 320, calendaring system 322, rejuvenation algorithm 326 and other program modules 328 may be operable on the processor 330.

The electronic device 300 may also include multiple input devices, output devices or combination input/output devices 332. The input and output devices or combination I/O devices 332 permit a user to operate and interface with the electronic device 300 and to control operation of the data structures 316 and 318 to enter rules, overrides or other criteria to control the rejuvenation process. The I/O devices 332 may include a keyboard or keypad, a computer pointing device or the like.

The I/O devices 332 may also include disk drives, optical, mechanical, magnetic, or infrared input/output devices, modems or the like. The I/O devices 332 may be used to access a medium 334. The medium 334 may contain, store, communicate or transport computer-readable or computer-executable instructions or other information for use by or in connection with a system, such as the electronic device 300.

The electronic device 300 may also include or be connected other devices, such as a display or monitor 336. The monitor or display 336 may be built-in as in the case of a laptop computer, PDA cellular telephone or the like. A video adapter 338 may be connected to the monitor 336.

The electronic device 300 may also include a hard disk drive 340. The hard drive 340 may also form part of the local file system or system memory 306. Programs, software and data may be transferred and exchanged between the system memory 306 and the hard drive 340 for operation of the electronic device 300.

The electronic device 300 may communicate with other devices or systems (not shown) similar to electronic device 300 via a network 342. A network interface 344 may couple the electronic device 300 to the network 342. The network interface 334 may be a modem, Ethernet card, router, gateway, wireless transceiver or the like for coupling the electronic device 300 to the network 328. The coupling may be a wired connection or wireless. The network 342 may be the Internet, private network, an intranet, wireless system, such as a cellular telephone system, or the like.

The energy storage unit 304 may be coupled to the components of the electronic device 300 by a power bus 346 to supply power to the other components. The energy storage unit 304 may be connectable to an external power source 348 for rejuvenation. The external power source 348 may be 110 voltage AC or similar power available from a public utility. The energy storage unit 304 may be connectable to the external power source 348 by a power conditioning apparatus 350. The power conditioning apparatus 350 may condition the voltage and current from the external power source 348 for proper and safe rejuvenation of the energy storage unit 304. The power conditioning apparatus 350 may include a transformer, converter, inverter or similar components to deliver the proper current and voltage to the energy storage unit 304 during a rejuvenation process. The rejuvenation algorithm 326 may control operation of the power conditioning apparatus 350. In the example of FIG. 3, the power conditioning apparatus 350 is illustrated as being external to the electronic device 300 but may also be a component within the device 300.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for performing a process, comprising:
predicting at least one permissible time period to perform the process; and
performing the process in response to one of detecting the at least one permissible time period, and both detecting the at least one permissible time period and a predetermined state.

2. The method of claim 1, further comprising scheduling the process during a next permissible time period in response to detecting the predetermined state.

3. The method of claim 1, further comprising performing the process in response to detecting the predetermined state and a current time period being the at least one permissible time period with sufficient time remaining in the at least one permissible time period to expect to substantially complete the process.

4. The method of claim 1, further comprising applying any rules, overrides and other predetermined criteria to the process.

5. The method of claim 1, wherein performing the process comprises performing a rejuvenation process on an energy storage unit, the method further comprising predicting the at least one permissible time period based on a selected probability of substantially completing the rejuvenation process before requiring power from the energy storage unit.

6. The method of claim 1, wherein predicting the at least one permissible time period to perform the process comprises:
collecting historical data related to use of an electronic device on which the process is to be performed; and
determining any recurring time periods when the electronic device is idle to to perform the process.

7. The method of claim 6, further comprising:
comparing a duration of each recurring time period to a duration to substantially complete the process; and
retaining each recurring time period that exceeds the duration to substantially complete the process.

8. The method of claim 7 further comprising:
applying any predetermined rules, overrides and other criteria to the retained recurring time periods; and
associating any retained recurring time periods that satisfy any predetermined rules, overrides and other criteria with a clock and calendaring system associated with the electronic device to define permissible time periods to perform the rejuvenation process.

9. A system for performing a process, comprising:
a data structure to predict at least one permissible time period to perform a the process; and
a data structure to perform the process in response to one of detecting the at least one permissible time period, and both detecting the at least one permissible time period and a predetermined state.

10. The system of claim 9, further comprising a data structure to schedule the process during a next permissible time period in response to detecting the predetermined state.

11. The system of claim 9, wherein the process comprises a rejuvenation process on an energy storage unit, the system further comprising a data structure to predict the at least one permissible time period based on a selected probability of substantially completing the rejuvenation process before requiring power from the energy storage unit.

12. The system of claim 9, wherein the data structure to predict the at least one permissible time period comprises a data structure to determine any recurring time periods when an electronic device on which the process is to be performed is idle to perform the process.

13. The system of claim 12, further comprising:
a data structure to compare a duration of each recurring time period to a duration to substantially complete the process; and
a system memory to retain each recurring time period that exceeds the duration to substantially complete the process.

14. The system of claim 13, further comprising:
a data structure to apply any predetermined rules, overrides and other criteria to the retained recurring time periods; and
a data structure to associate any retained recurring time periods that satisfy any predetermined rules, overrides and other criteria with a clock and calendaring system associated with the electronic device to define permissible time periods to perform the process.

15. A computer program product for rejuvenation of an energy performing a process, the computer program product comprising:
a computer readable medium having computer readable program code embodied therein, the computer readable medium comprising:
computer readable program code configured to predict at least one permissible time period to perform the process; and
computer readable program code configured to perform the process in response to one of detecting the at least one permissible time period, and both detecting the at least one permissible time period and a predetermined state.

16. The computer program product of claim 15, further comprising computer readable program code configured to schedule the process during a next permissible time period in response to detecting the predetermined state.

17. The computer program product of claim 15, wherein the process comprises a rejuvenation process on an energy storage unit, the computer program product further comprising computer readable program code configured to predict the at least one permissible time period based on a selected probability of substantially completing the rejuvenation process before requiring power from the energy storage unit.

18. The computer program product of claim 15, wherein the computer readable program code configured to predict at least one permissible time period comprises computer readable program code configured to determine any recurring time periods when an electronic device on which the process is to be performed is idle to perform the process.

19. The computer program product of claim 18, further comprising:
computer readable program code configured to compare a duration of each recurring time period to a duration to substantially complete the process; and
computer readable program code configured to facilitate retaining each recurring time period that exceeds the duration to substantially complete the process.

20. The computer program product of claim 17, further comprising:
computer readable program code configured to apply any predetermined rules, overrides and other criteria to the retained recurring time periods; and
computer readable program code configured to associate any retained recurring time periods that satisfy any predetermined rules, overrides and other criteria with a clock and calendaring system associated with the electronic device to define permissible time periods to perform the process.

21. The method of claim 1, wherein performing the process comprises performing rejuvenation of an energy storage unit in response to one of detecting the at least one permissible time period, and both detecting the at least one permissible time period and the energy storage unit being in a predetermined state.
